(19) United States
(12) Patent Application Publication
(10) Pub. No.: US 2026/0158455 A1
(43) Pub. Date: Jun. 11, 2026

(54) POWDER MIXER

(71) Applicant: WOOWON CO., LTD., Ansan-si, Gyeonggi-do (KR)

(72) Inventor: Hyun-Yong CHO, Incheon (KR)

(73) Assignee: WOOWON CO., LTD., Ansan-si, Gyeonggi-do (KR)

(21) Appl. No.: 18/708,335

(22) PCT Filed: Mar. 21, 2024
(86) PCT No.: PCT/KR2024/003581

§ 371 Date: May 8, 2024

(30) Foreign Application Priority Data
Mar. 28, 2023 (KR) 10-2023-0040256

(51) Int. Cl. B01F 23/64; B01F 27/113; B01F 27/1152; B01F 27/192; B01F 27/2122; B01F 27/806; B01F 27/84; B01F 35/32

(52) U.S. Cl. CPC B01F 23/64; B01F 27/113; B01F 27/1152; B01F 27/192; B01F 27/2122; B01F 27/806; B01F 27/84; B01F 35/3204; B01F 35/3213

(57) ABSTRACT

An objective of the present disclosure is to provide a powder mixer that prevents raw materials from being gathered to a side due to a centrifugal force generated by rotation of blades and enables raw materials that are mixed to be easily mixed with each other by rotating two impellers in opposite directions in mixing by the mixer. In order to achieve the objective, the powder mixer according to the present disclosure includes: a housing in which provided raw materials are mixed; an impeller unit connected to a bottom of the housing; a cover covering a top of the housing; and an actuator actuating the impeller unit.

### TECHNICAL FIELD

The present disclosure relates to a powder mixer and, in more detail, a powder mixer that enables two or more kinds of powders to be easily mixed with each other.

### BACKGROUND ART

In general, in order to mix two or more kinds of powders into a product or make a raw powder for producing a complete product by mixing two or more kinds of powders, it is possible to uniformly mix powders and produce various products using a mixed raw powder.

Such a powder mixer, as shown in FIG. 1A and FIG. 1B, includes: a housing 20 that has a power inlet 21 at the upper end and has a powder outlet at the lower end of a side; a ventilation floor 30 that is disposed at the same height as the powder outlet 22 in the housing 20, of which the edge is in close contact with the inner circumferential surface of the housing 20, of which the entire surface is a concave surface 31, and that has a slider 32 inclined to the powder outlet 22; a stirrer 40 that is rotationally coupled to a rotary motor 42 under the ventilation floor 30 and has stirring blades 42 disposed at the upper end thereof and exposed to the inside of the housing 20 through the ventilation floor 30; and an air nozzle 50 that is disposed under the ventilation floor 30 and sprays air to powders stacked on the ventilation floor 30, in which a ventilation segment frame 60 having a plurality of air passages 63 by partitions 62 is in close contact with the bottom of the ventilation floor 30 and the air nozzle 50 is disposed under each of the air passages 63.

According to such a powder mixer having this configuration of the related art, powders are fed into the powder inlet 21 and are mixed by rotating the stirring blades 42, and simultaneously, air is sprayed into the housing 20 using the air nozzles 50 so that the powders are scattered and mixed in the housing 20, whereby the powder mixture is discharged outside through the powder outlet 22.

However, such a powder mixer of the related art has a problem that raw materials that are mixed are gathered to a side by a centrifugal force generated by rotation of the blades in mixing, so uniform mixing is impossible.

Further, the powder mixer of the related art has a problem that since impeller is rotated in one direction in mixing, raw materials that are mixed are not easily mixed with each other.

### DISCLOSURE

### Technical Problem

In order to solve the problems of the related art described above, an objective of the present disclosure is to provide a powder mixer that prevents raw materials from being gathered to a side due to a centrifugal force generated by rotation of blades and enables raw materials that are mixed to be easily mixed with each other by rotating two impellers in opposite directions in mixing by the mixer.

### Technical Solution

In order to achieve the objective, the powder mixer according to the present disclosure includes: a housing in which provided raw materials are mixed; an impeller unit connected to a bottom of the housing; a cover covering a top of the housing; and an actuator actuating the impeller unit.

Further, in the powder mixer according to the present disclosure, the impeller unit includes: a first rotary shaft having a hollow shape; and a first impeller being rotated in a first direction by the first rotary shaft.

Further, in the powder mixer according to the present disclosure, the first impeller is connected at a center to the first rotary shaft and both ends of the first impeller are bent toward the inside of the housing.

Further, in the powder mixer according to the present disclosure, the first impeller blows the raw materials that sink down using rotation force in the first direction when the raw materials are mixed.

Further, in the powder mixer according to the present disclosure, the actuator includes a first actuating motor that actuates the first rotary shaft.

Further, in the powder mixer according to the present disclosure, the impeller unit includes: a second rotary shaft inserted in the first rotary shaft; and a second impeller being rotated in a second direction by the second rotary shaft.

Further, in the powder mixer according to the present disclosure, the second impeller is composed of a ring and a plurality of blades that is connected at a first side to an outer circumference of the ring with predetermined intervals along the outer circumference of the ring and that is connected at a second side to the rotary shaft.

Further, in the powder mixer according to the present disclosure, the second impeller moves up and down the raw materials using rotation force in the second direction when the raw materials are mixed.

Further, in the powder mixer according to the present disclosure, the actuator includes a second actuating motor that actuates the second rotary shaft.

Further, in the powder mixer according to the present disclosure, the housing includes a discharger disposed on a side of the housing to discharge a raw material mixture, a binder tank through which assistant raw materials are fed is disposed over the actuator, the cover includes an anti-gathering unit having a support rod connected at a first side with the cover and an anti-gathering face formed at a second side of the support bar and having a shape curved inward, a spray nozzle is connected to the binder tank and the cover, and the spray nozzle uniformly sprays assistant raw materials into the housing.

Details of other embodiments are included in “detailed description of the invention” and the accompanying “drawings”.

The advantages and/or features of the present disclosure, and methods of achieving them will be clear by referring to the exemplary embodiments that will be describe hereafter in detail with reference to the accompanying drawings.

However, it should be noted that the present disclosure is not limited to the configuration of each of embodiments to be described hereafter and may be implemented in various ways, and the exemplary embodiments described in the specification are provided to complete the description of the present disclosure and let those skilled in the art completely know the scope of the present disclosure and the present disclosure is defined by claims.

### Advantageous Effects

According to the present disclosure, there is an effect of preventing raw materials from being gathered to a side due to a centrifugal force generated by rotation of blades and enabling raw materials that are mixed to be easily mixed with each other by rotating two impellers in opposite directions in mixing by a mixer.

### DESCRIPTION OF DRAWINGS

FIG. 1A and FIG. 1B are perspective view showing the configuration of a powder mixer of the related art.

FIG. 2 is a perspective view of a powder mixer according to the present disclosure seen from the front.

FIG. 3 is a perspective view of the powder mixer according to the present disclosure seen from the rear.

FIG. 4 is a view showing an actuation relationship of an actuator and an impeller unit of the powder mixer according to the present disclosure.

FIG. 5 is a view showing the inside of a housing of the powder mixer according to the present disclosure.

FIG. 6 is a perspective view showing an anti-gathering unit of the powder mixer according to the present disclosure.

FIG. 7 is a perspective view showing the impeller unit of the powder mixer according to the present disclosure.

FIG. 8 is a perspective view showing a first impeller and a second impeller of the impeller unit of the powder mixer according to the present disclosure.

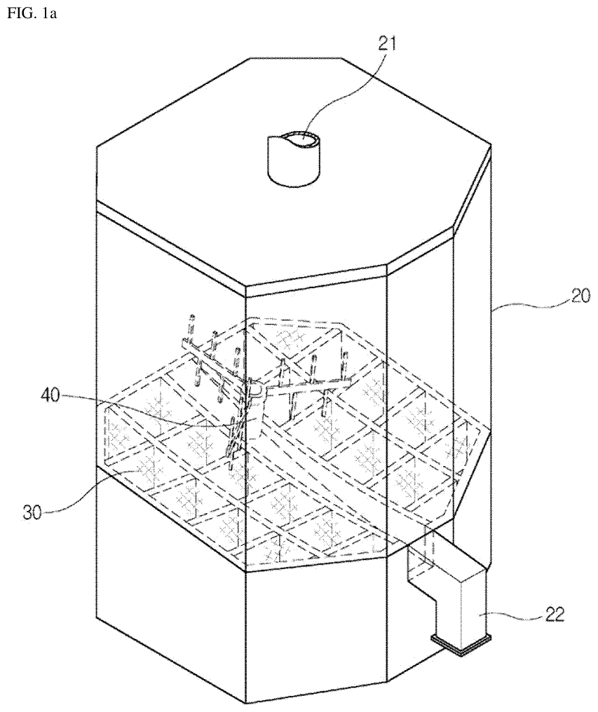

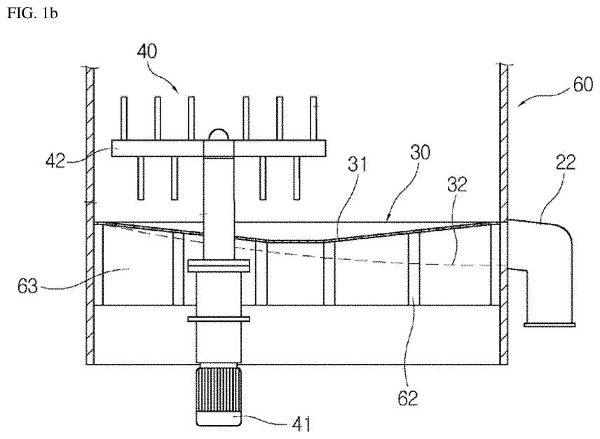

### BEST MODE

The present disclosure provides a powder mixer that prevents raw materials from being gathered to a side due to a centrifugal force generated by rotation of blades and enables raw materials that are mixed to be easily mixed with each other by rotating two impellers in opposite directions in mixing.

### Mode for Invention

Before describing the present disclosure in detail, terms or words used herein should not be construed as being limited to common or dictionary meanings, the concepts of various terms may be appropriately defined to the most optimally describe the invention by the inventor(s), and it should be noted that those terms or words should be construed as meanings and concepts corresponding to the technical spirit of the present disclosure.

That is, it should be noted that the terms used herein are used only to describing preferred embodiments of the present disclosure, not intending to limit the present disclosure in detail, and those terms are terms defined in consideration of various possibilities of the present disclosure.

Further, it should be noted that, in the specification, singular expression may include plural expression unless clearly stated in the sentences, and includes a singular meaning even if it is similarly expressed as a plural number.

It should be noted that when a component is described as “including” another component throughout the specification, the component may further include another component without another component excluded, unless specifically stated otherwise.

Further, it should be noted that when a component is described as “exists in” and “is connected to” another component, the component may be directly connected with another component, may be installed in contact with another component, or may be installed with a predetermined gap. When the component is installed with a gap, there may be a third component or means for fixing and connecting the component to another component, and the third component or means may not be described.

On the other hands, it should be understood that when a component is described as “directly connected” or “indirectly connected” to another component, it should be construed as there is no third component or means.

Similarly, the terms used herein to describe a relationship between elements, that is, “between”, “directly between”, “adjacent” or “directly adjacent” should be interpreted in the same manner as those described above.

Further, in the specification, it should be noted that terms such as “first side”, “second side”, “first”, and “second”, if used, are used to clearly discriminate one components from another component and the meaning of the corresponding component is not limited by the terms.

Further, terms related to positions such as “up”, “down”, “left”, and “right”, if used herein, should be construed as indicating relative positions of corresponding components in the corresponding figures and should not be construed as stating absolute positions unless the absolute positions of them are specified.

Further, in the specification, when components are given reference numerals, the same reference numerals are given to same components even if they are shown in different figures, that is, same reference numerals indicate same components throughout the specification.

The size, position, coupling relationship, etc. of components of the present disclosure may be partially exaggerated or reduced in the accompanying drawings for the convenience of description in order to sufficiently and clearly transmit the spirit of the present disclosure, so the proportion or scale may not be precise.

Further, in the following description of the present disclosure, components that are determined to unclearly make the spirit of the present disclosure unclear, for example, well-known technology including the related art may not be described in detail.

Hereafter, embodiments of the present disclosure are described in detail with reference to relevant drawings.

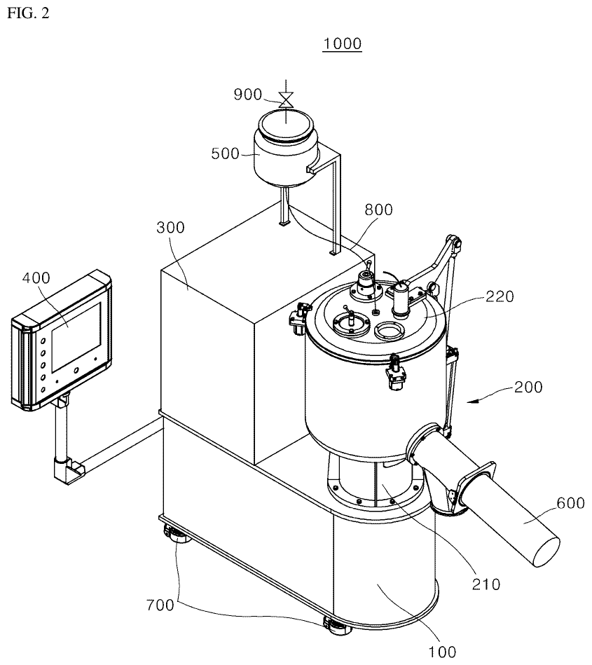

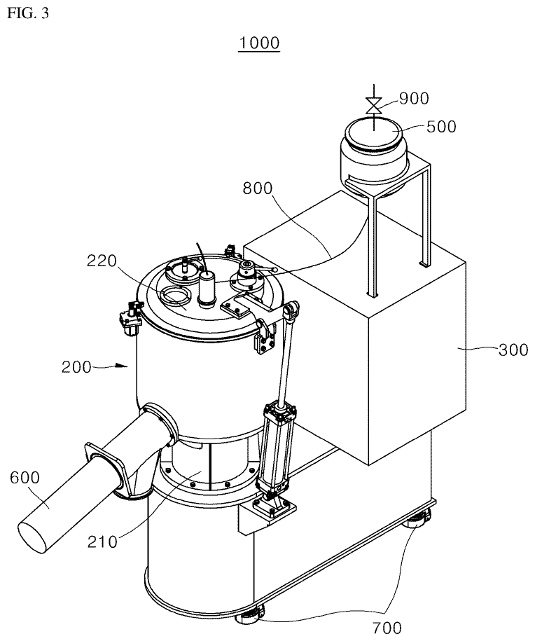

FIG. 2 is a perspective view of a powder mixer according to the present disclosure seen from the front and FIG. 3 is a perspective view of the powder mixer according to the present disclosure seen from the rear.

Referring to FIG. 2 and FIG. 3, a powder mixer 1000 according to the present disclosure includes a work table 100, a housing 200, an actuator 300, a controller 400, a binder tank 500, a discharger 600, a holder 700, a spray nozzle 800, and an air valve 900.

The work table 100 serves to support components of the powder mixer 1000.

The work table enables a worker to work in an erect state, so the work environment can be greatly improved in comparison to working without the work table.

The housing 200 serves to mix provided raw materials (powders).

The housing 200 has a cylindrical shape with an open top and the open top of the housing 200 is closed by a lid 220.

Further, a cooler (not shown in the drawings) disposed on the outer surface of the housing 200 may be further included to prevent an increase of the temperature of the housing 200 when mixing raw materials.

Such a cooler serves to decrease the temperature of the housing 200 when the temperature of the housing 200 increases, and the cooler that maintains the internal temperature of the housing 200 at a predetermined temperature may include a Peltier device for temperature control.

The cooler may have a Peltier device for maintaining the internal temperature of the housing 200 at a predetermined temperature. The cooler may be formed in a structure in which a Peltier device is positioned at the center, heat dissipation plates are disposed at both sides, and a fan unit for suctioning or discharging air, which is heated and cooled, into or out of the housing 200 is disposed outside the heat dissipation plates.

In this configuration, temperature may be adjusted using the Peltier device.

The Peltier device is a device that maintains a temperature difference between both ends of the device using Peltier effect.

Peltier effect means a phenomenon in which when a current is applied, a temperature difference is maintained at both ends of several conductive substance layers, and a device that uses this effect is called a Peltier device or a thermoelectric element.

That is, a Peltier device is a device that generates an effect that when an opposite high-temperature part that needs to be cooled to a low temperature is forcibly cooled, the heat of the low-temperature part transfers to the high-temperature part, and it is possible to adjust temperatures at both sides of a Peltier device, depending on the direction of a current that is applied. A Peltier device, heat dissipation plates, and a fan are disposed on a side of the powder mixer 1000 according to an embodiment of the present disclosure, so when the internal temperature of the housing 200 increases over an appropriate temperature, the part of the Peltier device that faces the housing 200 is cooled and cooled air is suctioned through the fan unit, whereby it is possible to decrease the internal temperature of the housing 200. Further, when the internal temperature of the housing 200 decreases under the appropriate temperature, the part of the Peltier device that faces the housing 200 is heated and heated air is suctioned through the fan unit, whereby it is possible to increase the internal temperature of the housing 200. Accordingly, it is possible to maintain the internal temperature of the housing 200 within a preset appropriate temperature range.

Meanwhile, the actuator 300 serves to actuate the impeller unit 210 to be described below.

The actuator 300 is formed in a square prism box shape, and a first actuating motor 310 and a second actuating motor 311 to be described below are mounted in the box shape.

The controller 400 is formed in a monitor shape and serves to control various functions of the powder mixer 1000 according to the present disclosure and control all of the components.

The controller 400 can be controlled in a touch screen type and can be controlled by a manager who manages the powder mixer 1000 according to the present disclosure.

The binder tank 500 functions as an assistant raw material inlet.

The discharger 600 serves to discharge a raw material mixture in the housing 200.

The discharger 600 is installed on a side of the housing 200 and is inclined lower than the height of the housing 200.

Accordingly, a user can take a raw material mixture discharged from the housing 200 by putting a container, etc. under the discharger 600.

A plurality of holders 700 is mounted on the bottom of the work table 100 and serves to fix the powder mixer 1000 while supporting the work table.

Meanwhile, the powder mixer 1000 may further include a moving part (not shown) adjacent to the holders 700 and it may be possible to move the powder mixer 1000 through the moving part.

The spray nozzle 800 is connected with the binder tank 500 and connected with the housing 200 through a hole formed at the cover 220 covering the housing 200.

Assistant raw materials such as oil in the binder tank 500 are uniformly sprayed downward into the housing 200 through the spray nozzle 800, whereby there is an effect of preventing raw materials that are mixed in the housing 200 from conglomerating.

The assistant raw materials such as oil that are uniformly sprayed downward by the spray nozzle 800 are sprayed while being controlled by the controller 400.

Further, it may be possible to inject air into the housing 200 through the spray nozzle 800.

Such air is adjusted by the air valve 900 over the binder tank 500 and is injected into the housing 200 by the spray nozzle 800.

The air valve 900 is controlled by a manager through the controller 400.

In more detail, the powder mixer 1000 according to the present disclosure includes, as main components, the work table 100, the housing 200, the impeller unit 210, the cover 220, and the actuator 300.

The housing 200 is positioned at a side on the work table 100 and provided raw materials are mixed therein.

The impeller unit 210 is connected to the bottom of the housing 200 and serves to mix raw materials fed in the housing 200.

The cover 220 covers the top of the housing 200.

The actuator 300 is positioned at another side on the work table 100 and serves to actuate the impeller unit 210.

Further, the discharger 600 is installed on the side of the housing 200 and serves to discharge a raw material mixture in the housing 200.

Further, the binder tank 500 is installed over the actuator 300 and functions as an assistant raw material inlet through which assistant raw materials are fed.

Meanwhile, the spray nozzle 800 can be connected between the binder tank 500 and the cover 220. The spray nozzle 800 serves to uniformly spray assistant raw materials such as oil or inject air downward into the housing 200.

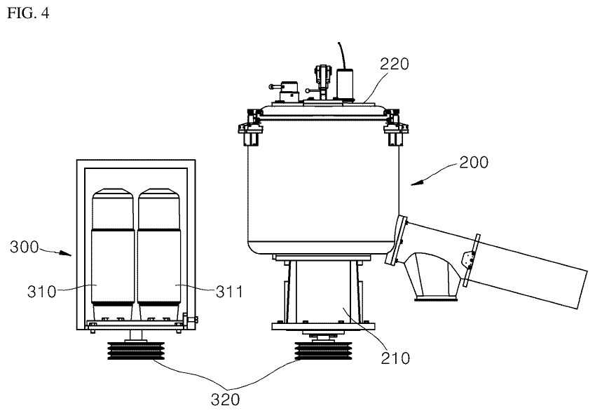

FIG. 4 is a view showing an actuation relationship of an actuator and an impeller unit of the powder mixer according to the present disclosure.

Referring to FIG. 4, the actuator 300 of the powder mixer 1000 according to the present disclosure actuates the impeller unit 210.

The actuator 300 includes a first actuating motor 310 that actuates a first rotary shaft 211 to be described below.

Further, the actuator 300 includes a second actuating motor 311 that actuates a second rotary shaft 212 to be described below.

In this configuration, the first actuating motor 310 and the second actuating motor 311 are mounted in the actuator 300. The first actuating motor 310 and the second actuating motor 311 are connected with the impeller unit 210 through pulleys 320, thereby actuating the impeller unit 210.

In more detail, the actuating motors actuate the first impeller 211 and the second impeller 212 of the impeller unit 210.

The pulley 320 is a cylindrical wheel holding a belt and is also called a belt wheel.

The pulley is a friction wheel that is used at driving and driven shafts in winding power transmission, and there are pulleys for a flat belt, a V-belt, a toothed belt, etc.

Pulleys for a flat belt are generally formed in a cylindrical shape, but a conical shape is used when a speed ratio is sequentially changed and a stepped wheel is used when a speed ratio is changed step by step.

For a flat belt, the outer surface of a pulley may be flat, but, generally, when the center portion is formed slight higher, a belt is difficult to be pulled.

Further, there are a separate type and an integral type in terms of structure.

Cast iron is generally used, but a light alloy, an iron plate, etc. are used for high speeds and wood is also used in some cases to decrease the weight.

The rotation force generated by the first actuating motor 310 and the second actuating motor 311 rotates the first impeller 211 and the second impeller 212 of the impeller unit 210 through the pulleys 320.

Of course, since the actuator 300 includes two actuating motors and the impeller unit 210 includes two impellers, two pulleys 320 are provided.

That is, the first actuating motor 310 rotates the first impeller 211 through a first pulley and the second actuating motor 311 rotates the second impeller 212 through a second pulley.

In more detail, the first actuating motor 310 rotates the first rotary shaft 211 through a first pulley and the second actuating motor 311 rotates the second rotary shaft 212 through a second pulley.

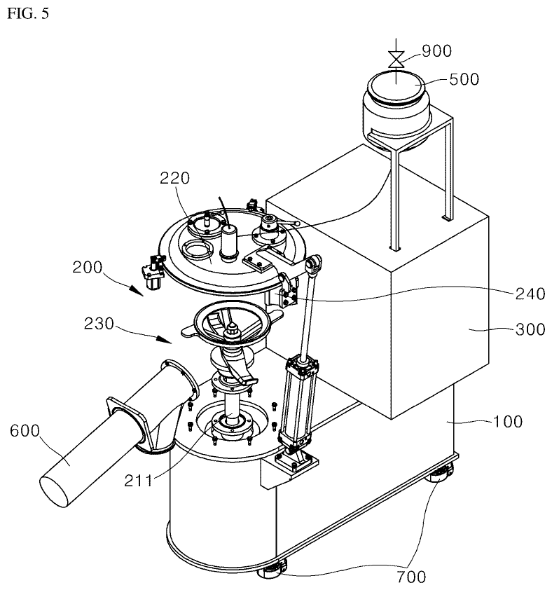

FIG. 5 is a view showing the inside of a housing of the powder mixer according to the present disclosure.

Referring to FIG. 5, it is possible to see the inside of the housing 200 and the impeller unit 210 of the powder mixer 1000 according to the present disclosure.

An anti-gathering unit 240 is positioned in the housing 200 and an impeller 230 is positioned on the impeller unit 210.

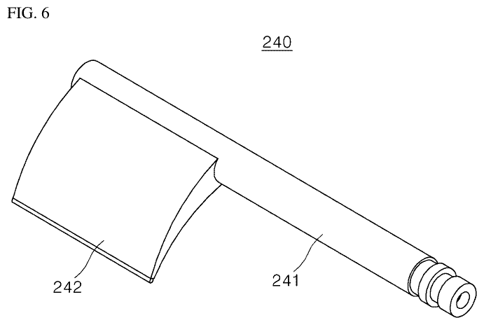

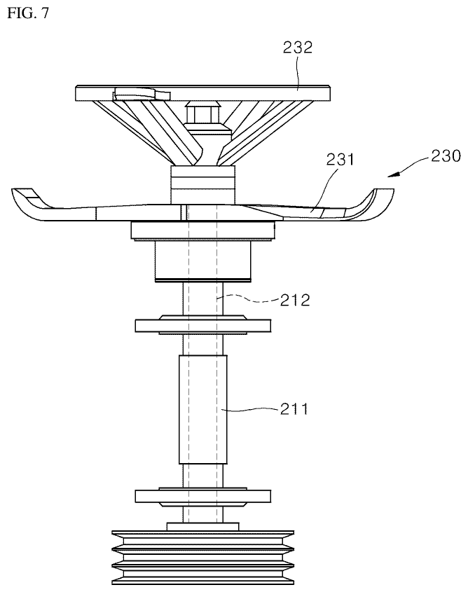

The anti-gathering unit 240 is described in more detail with reference to FIG. 6 and the impeller 230 is described in more detail with reference to FIG. 7.

FIG. 6 is a perspective view showing an anti-gathering unit of the powder mixer according to the present disclosure.

Referring to FIG. 6, the anti-gathering unit 240 of the powder mixer 1000 according to the present disclosure includes a support rod 241 and an anti-gathering face 242.

The anti-gathering unit 240 is connected with the inner surface of the cover 220.

That is, the anti-gathering unit 240 has a support rod 241 connected with the cover 220 at a first side and an anti-gathering face 242 formed at a second side of the support rod 241 and having a shape curved inward.

The first side of the support rod 241 of the anti-gathering unit 240 is connected with the cover 220.

The manner of connecting the first side of the support rod 241 to the cover 220 is various.

For example, it may be connected in a thread-fastening type, but is not limited thereto and may be connected in various connection types.

Meanwhile, the anti-gathering face 242 is formed in a curved shape at the second side of the support rod 241.

In particular, the curved shape of the anti-gathering face 242 has a curved shape curved toward the inside of the housing 200.

Raw materials that are mixed in the housing 200 may gather outward in the housing 200 by a centrifugal force generated by rotation of the impeller 230.

Raw materials that are gathered outward by a centrifugal force hit against the anti-gathering face 242, whereby they are moved back inward in the housing 200.

As described above, the anti-gathering unit 240 of the powder mixer 1000 according to the present disclosure has an effect of preventing a gathering phenomenon in which raw materials that are mixed in the housing 200 are gathered outward in the housing 200 by a centrifugal force.

Meanwhile, the anti-gathering face 242 may further include a temperature sensor (not shown).

The temperature sensor senses and shows the internal temperature of the housing 200, in which raw materials are being mixed, on the controller 400, whereby there is an effect of preventing raw materials that are being mixed from burning or changing colors.

FIG. 7 is a perspective view showing the impeller unit of the powder mixer according to the present disclosure.

Referring to FIG. 7, the impeller unit 210 of the powder mixer 1000 according to the present disclosure includes the first rotary shaft 211, the second rotary shaft 212, and the impeller 230 including the first impeller 231 and the second impeller 232.

When the first actuating motor 320 is operated, the actuating force of the first actuating motor 310 is transmitted to the first rotary shaft 211 through the first pulley, whereby the first rotary shaft 211 is rotated.

Further, when the second actuating motor 311 is operated, the actuating force of the second actuating motor 311 is transmitted to the second rotary shaft 212 through the second pulley, whereby the second rotary shaft 212 is rotated.

That is, the first impeller 231 and the second impeller 232 are rotated by rotation of the first rotary shaft 211 and the second rotary shaft 212, respectively.

Different raw materials, that is, different powders in the housing 200 are more easily mixed by rotation of the impeller 230 including the first impeller 231 and the second impeller 232.

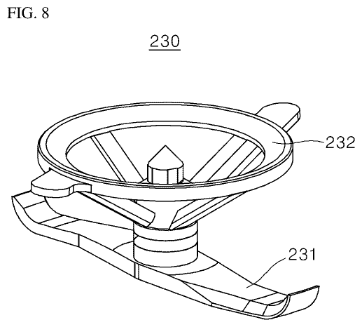

FIG. 8 is a perspective view showing a first impeller and a second impeller of the impeller unit of the powder mixer according to the present disclosure.

Referring to FIG. 8, the impeller 230 of the powder mixer 1000 according to the present disclosure includes the first impeller 231 and the second impeller 232.

The first impeller 231 is rotated in a first direction by the first rotary shaft 211 operated by the first actuating motor 310.

The first rotary shaft 211 has a hollow shape.

The first impeller 231 is connected at the center to the first rotary shaft 211 and has a shape in which both ends are bent toward the inside of the housing 200.

That is, the first impeller 231 is formed in a bar shape of which both ends are bent toward the inside of the housing 200 and the center is connected to the first rotary shaft 211.

Accordingly, when the first rotary shaft 211 is rotated, the first impeller 231 is rotated in one direction.

When the first impeller 231 is rotated, raw materials in the housing 200 are mixed, and, in this process, the raw materials sinking down in the housing 200 are blown.

That is, the first impeller 231 blows raw materials that sink down when they are mixed.

Accordingly, raw materials in the housing 200 are blown up without sinking down, whereby there is an effect that raw materials are uniformly mixed.

Further, in the powder mixer 1000 according to the present disclosure, the second impeller 232 is composed of a ring and a plurality of blades that is connected at a first side to the outer circumference of the ring with predetermined intervals along the outer circumference of the ring and that is connected at a second side to the second rotary shaft 212.

First, in the powder mixer 1000 according to the present disclosure, the impeller unit 210 includes the second rotary shaft 212 and the second impeller 232.

The first rotary shaft 211 has a hollow shape.

The second rotary shaft 212 is inserted in the first rotary shaft 211.

The second impeller 232 is rotated in a second direction by the second rotary shaft 212 operated by the second actuating motor 311.

The second impeller 232 includes a ring and a plurality of bar-shaped blades.

In this configuration, first sides of the plurality of blades are connected to the outer circumference of the ring and second sides thereof are connected to the second rotary shaft 212.

Of course, the first sides of the plurality of blades are connected to the outer circumference of the ring with predetermined intervals along the outer circumference of the ring and the second sides of the plurality of blades are connected to the outer circumference of the second rotary shaft 212 with predetermined intervals along the outer circumference of the second rotary shaft 212.

When the second impeller 232 is rotated, raw materials in the housing 200 are mixed, and, in this process, the raw materials in the housing 200 are mixed while moving up or down.

That is, when raw materials are mixed, the second impeller 232 moves up and down the raw materials by rotation force of the second impeller 232.

Accordingly, raw materials in the housing 200 are mixed while moving up or down, whereby there is an effect that raw materials are uniformly mixed.

Further, the first impeller 231 and the second impeller 232 each may include a chopper blade.

The chopper blades serve to pulverize raw materials when the raw materials are mixed.

Since raw materials are pulverized by the chopper blades, there is an effect that raw materials are uniformly mixed.

In other words, according to the powder mixer 1000 of the present disclosure, gathering of raw materials due to a centrifugal force generated by rotation of blades is prevented by the first impeller 231 that is rotated in a first direction by rotation of the first rotary shaft 211 operated by the first actuating motor 310 and the second impeller 232 that is rotated in a second direction by rotation of the second rotary shaft 212 operated by the second actuating motor 311, and two impellers are rotated in opposite directions in mixing by the mixer, whereby raw materials that are mixed are easily mixed with each other.

In particular, since the second rotary shaft 212 is inserted in the first rotary shaft 211, they are rotated in opposite directions without influencing each other, whereby there is an effect that raw materials are easily mixed with each other.

Further, the powder mixer 1000 according to an embodiment described above requires two actuating motors to rotate the second rotary shaft 212 in a second direction when rotating the first rotary shaft 211 in a first direction in order to easily mix raw materials with each other.

That is, the first rotary shaft 211 is rotated in a first direction by the first actuating motor 310 and the second rotary shaft 212 is rotated in a second direction by the second actuating motor 311.

However, when two actuating motors (the first actuating motor 310 and the second actuating motor 311) are used, as described above, there is a need for a space that is occupied by the two actuating motors in the work table 100. In this case, the volume of the powder mixer 1000 is increased and a work space for a worker may decrease.

Accordingly, a configuration of easily mixing raw materials with each other using one actuating motor is described in another embodiment of the present disclosure.

The configuration of a powder mixer 1000 according to another embodiment of the present disclosure is very similar to the configuration of the powder mixer 1000 described above, but uses only one actuating motor.

That is, in the powder mixer 1000 according to another embodiment of the present disclosure, the actuator 300 includes only one actuating motor and the first actuating motor 310 is described for the convenience of description.

Accordingly, in this embodiment, the first actuating motor 310 rotates only the second rotary shaft 212 through the first pulley.

According to this configuration, only the second impeller 232 is rotated in a first direction by rotation of the second rotary shaft 212 operated by the first actuating motor 310.

In this case, the first rotary shaft 211 is not rotated, and as the first rotary shaft 211 is not rotated, the first impeller 231 keeps supported by the first rotary shaft without rotating.

By this configuration, when the second impeller 232 is rotated in the first direction by rotation of the second rotary shaft 212, the first impeller 231 supported by the first rotary shaft 211 functions as a barrier that interferes with rotation of the second impeller 232.

Accordingly, there is an effect that raw materials are easily mixed with each other by rotation of the first impeller 231 operated by rotation of the first rotary shaft 211 and by the second impeller 232 interfering with rotation of the first impeller 231.

Meanwhile, the powder mixer 1000 according to another embodiment of the present disclosure rotates the first rotary shaft 211 and the second rotary shaft 212 in opposite directions using one actuating motor so that raw materials are easily mixed with each other, and this configuration is described.

That is, in this embodiment, a gear between the first rotary shaft 211 and the second rotary shaft 212 may be further included.

First, the first actuating motor 310 rotates only the second rotary shaft 211 through the first pulley.

In this case, when the first rotary shaft 211 is rotated in a first direction, the first impeller 231 is also rotated and the gear mounted between the first rotary shaft 211 and the second rotary shaft 212 is also operated.

The second rotary shaft 212 rotates the second impeller 232 while being rotated in a second direction by this operation of the gear.

As an example of the gear, there is a geared motor.

In the configuration of rotating two rotary shafts in opposite directions using one motor, it is possible to transmit the rotation force of the motor to the two rotary shafts using a geared motor.

Various kinds of motors may be used for the geared motor, but they can be selected in accordance with desired rotation speed and rotation direction.

For example, the geared motor may include a planetary geared motor, a spiral bevel geared motor, a parallel shaft geared motor, a stepper motor geared motor, a worm geared motor, etc.

Accordingly, two rotary shafts are rotated in opposite directions by only one actuating motor and there is an effect that raw materials are easily mixed with each other by the first impeller 231 and the second impeller 232 that are rotated in opposite directions in this way.

As described above, according to the present disclosure, there is an effect of preventing raw materials from being gathered to a side due to a centrifugal force generated by rotation of blades and enabling raw materials that are mixed to be easily mixed with each other by rotating two impellers in opposite directions in mixing by a mixer.

Various preferred embodiments of the present disclosure were described above through some examples, but the various embodiments described in “detailed description of the invention” are only examples and it would be clearly understood by those skilled in the art the present disclosure may be changed in various ways or equivalently implemented from the above description.

Further, it should be noted that since the present disclosure may be implemented in other various ways, the present disclosure is not limited to the above description, the above description is provided to completely explain the present disclosure and provided only to completely inform those skilled in the art of the range of the present disclosure, and the present disclosure is defined by only claims.

### INDUSTRIAL APPLICABILITY

The present disclosure has an effect of preventing raw materials from being gathered to a side due to a centrifugal force generated by rotation of blades and enabling raw materials that are mixed to be easily mixed with each other by rotating two impellers in opposite directions in mixing by a mixer.

1. A powder mixer comprising:
a housing in which provided raw materials are mixed;
a impeller unit connected to a bottom of the housing;
a cover covering a top of the housing; and
an actuator actuating the impeller unit.

2. The powder mixer of claim 1, wherein the impeller unit includes:
a first rotary shaft having a hollow shape; and
a first impeller being rotated in a first direction by the first rotary shaft.

3. The powder mixer of claim 2, wherein the first impeller is connected at a center to the first rotary shaft and both ends of the first impeller are bent toward the inside of the housing.

4. The powder mixer of claim 3, wherein the first impeller blows the raw materials that sink down using rotation force in the first direction when the raw materials are mixed.

5. The powder mixer of claim 2, wherein the actuator includes a first actuating motor that actuates the first rotary shaft.

6. The powder mixer of claim 1, wherein the impeller unit includes:
a second rotary shaft inserted in the first rotary shaft; and
a second impeller being rotated in a second direction by the second rotary shaft.

7. The powder mixer of claim 6, wherein the second impeller is composed of a ring and a plurality of blades that is connected at a first side to an outer circumference of the ring with predetermined intervals along the outer circumference of the ring and that is connected at a second side to the rotary shaft.

8. The powder mixer of claim 6, wherein the second impeller moves up and down the raw materials using rotation force in the second direction when the raw materials are mixed.

9. The powder mixer of claim 6, wherein the actuator includes a second actuating motor that actuates the second rotary shaft.

10. The powder mixer of claim 1, wherein the housing includes a discharger disposed on a side of the housing to discharge a raw material mixture,
a binder tank through which assistant raw materials are fed is disposed over the actuator,
the cover includes an anti-gathering unit having a support rod connected at a first side with the cover and an anti-gathering face formed at a second side of the support bar and having a shape curved inward,
a spray nozzle is connected to the binder tank and the cover, and
the spray nozzle uniformly sprays assistant raw materials into the housing.
